(19) United States
(12) Patent Application Publication
(10) Pub. No.: US 2008/0223846 A1
(43) Pub. Date: Sep. 18, 2008

(54) Electrical heating apparatus

(75) Inventor: Dominique Akel, Paris (FR)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: ELKA S.A., Chartres (FR)

(21) Appl. No.: 12/002,570

(22) Filed: Dec. 17, 2007

(30) Foreign Application Priority Data
Mar. 16, 2007 (FR) 07 53 875

(51) Int. Cl. F27D 11/00

(52) U.S. Cl. 219/441

(57) ABSTRACT

An electrical heating apparatus having an emitting surface, in particular in the form of a panel. It comprises a heating device having a vessel receiving a small volume of low-boiling-temperature phase-transition liquid, and an electrical heating body for the liquid in the vessel, a closed casing forming the emitting surface, surmounting the vessel and in communication with the latter to form a pressure-resistant hermetic enclosure for the liquid vapour and the condensate.

### FIELD OF THE INVENTION

The present invention relates to an electrical heating apparatus having an emitting surface, in particular in the form of a panel.

### PRIOR ART

There are various electrical heating apparatus systems, in particular in the form of panels, for domestic use by consumers. These heating apparatuses use either convection or radiation.

Electrical convectors are formed by a case accommodating electrical resistance which heats circulating air entering the case at the lower portion and leaving at the upper portion.

Apparatuses operating by radiation have an emitting surface formed by an enclosure containing a volume of liquid heated by an immersion heater, such as, for example, towel-drying radiators in bathrooms. There are also apparatuses for heating by radiation which comprise solid elements composed of ceramic material, aluminium or cast iron with enclosed electrical resistors. Those apparatuses are called “dry” inertia systems as opposed to the other “fluid” inertia systems.

Those heating apparatuses use electrical resistors having a power ranging from 500 to 2,500 Watts.

The thermal inertia of those apparatuses is relatively great, which reduces regulation efficiency and results in a fairly substantial consumption of electricity, which can be reduced only in a limited manner by programmable or non-programmable electromechanical or electronic regulation.

### OBJECT OF THE INVENTION

An object of the present invention is to develop an electrical heating apparatus which has an emitting surface, is efficient and which permits a substantial reduction in the consumption of electricity for the same heating quality and which is simple and economical to construct.

### STATEMENT AND ADVANTAGE OF THE INVENTION

To that end, the present invention relates to an electrical heating apparatus, characterized in that it comprises
A—a heating device having
   a vessel receiving a small volume of low-boiling-temperature phase-transition liquid, and
   an electrical heating body for the liquid in the vessel,
B—a closed casing forming the emitting surface, surmounting the vessel and in communication with the latter to form a pressure-resistant hermetic enclosure for the liquid vapour and the condensate.

The electrical heating apparatus according to the invention has the advantage of being extremely simple to produce and of functioning efficiently, owing to its low thermal inertia. This low thermal inertia is also particularly advantageous for rapidly bringing up to temperature the whole of the emitting surface formed by the panel; the heat-exchange liquid used in electrical heating apparatuses having “fluid” inertia is replaced by the hot vapour which is distributed rapidly over the entire heat exchange surface and above all regulates automatically the temperature of that heating surface since the points which could be cold constitute condensation points and therefore they will be re-heated in preference to the other portions of the heat exchange surface; thus, the emitting surface formed by the panel very rapidly assumes a uniform temperature. This temperature uniformity ensures efficient heat exchange with the outside, principally by radiation. The regular nature of the temperature of the whole of the emitting surface of the panel constitutes a very comfortable heating means owing to the large radiation surface and the regularity of the development of the temperature over time.

The low-boiling-temperature phase-transition liquid may be a liquid passing into the vapour state at a relatively low temperature and at ambient pressure, but also a liquid having a low boiling temperature at very low pressure, for example water placed in the enclosure in which some degree of vacuum has been produced.

The very low thermal inertia is also advantageous for the automatic regulation of the apparatus as a function of a desired temperature. The rapid reduction in the panel temperature when the heating body stops reduces losses and, overall, permits very accurate adoption of programmed heating.

The enclosure preferably comprises a condensation duct which leads into the upper portion of the enclosure and which is connected to the vessel to form a condensate trap in which the vapour condenses to descend into the duct and re-supply the vessel so that the latter is supplied permanently with liquid under the normal operating conditions of the apparatus (in the absence of overheating detected by the apparatus control system).

This permanent re-supply of the vessel permits the setting in circulation of the vapour, regulating to a considerable extent the operating temperature of the apparatus, which is particularly advantageous for the heating effect and the physiological impression of comfort provided by this electrical heating apparatus, while at the same time considerably reducing the power consumption by better use of the power available.

Depending on the size of the heating apparatus, that is to say, its power, one or more condensation ducts can be provided which are preferably installed on the sides of the apparatus, if the latter is in the form of a panel. These ducts may be integrated in the apparatus or may constitute an external element in the form of a tube having a small cross-section, which is placed, for example, at the rear of the enclosure, especially of the panel.

According to a further advantageous feature, the closed casing is a flat panel but it may also be a developable surface, such as an open or closed cylindrical surface or a conical surface, depending on the set-up of the heating apparatus. This great diversity of forms is made possible by the heat-exchange fluid, which is vapour, and by the very great regularity of the temperature of the emitting surface of the closed casing.

According to a further advantageous feature, the casing comprises vapour circulation paths in the form of chimneys. These chimneys regulate the distribution of the vapour over the entire surface in order to prevent preferential paths, which are generally the most direct, between the vapour source and the condensation surface.

According to a further advantageous feature, the control system comprises a thermostat and/or a programmable or non-programmable electromechanical or electronic regulating system and/or protective means for preventing overheating. Owing to safety regulations, the temperature of the emitting surface, that is to say, of the panel, must not exceed a temperature of, for example, 60° C.

According to a further advantageous feature, the heating body is an electrical resistor or a halogen light source, that is to say, a power semi-conductor. It may also be more generally a diode. The heating body is integrated in the vessel and immersed in the liquid. However, it may also be a heating body outside the vessel in order to be able to produce the enclosure, including the vessel, in a sealed manner and to leave the heating body on the outside, which renders it independent for the purpose of its replacement. The vessel may also be formed by a transparent surface and the heating body by a radiation source heating the liquid in the vessel through the transparent wall.

### DRAWINGS

The present invention will be described hereinafter in a more detailed manner by means of an embodiment shown in the appended drawings in which:

FIG. 1 is a simplified view of a heating apparatus according to the invention,

FIG. 2 is a simplified view of another embodiment.

### DESCRIPTION OF EMBODIMENTS

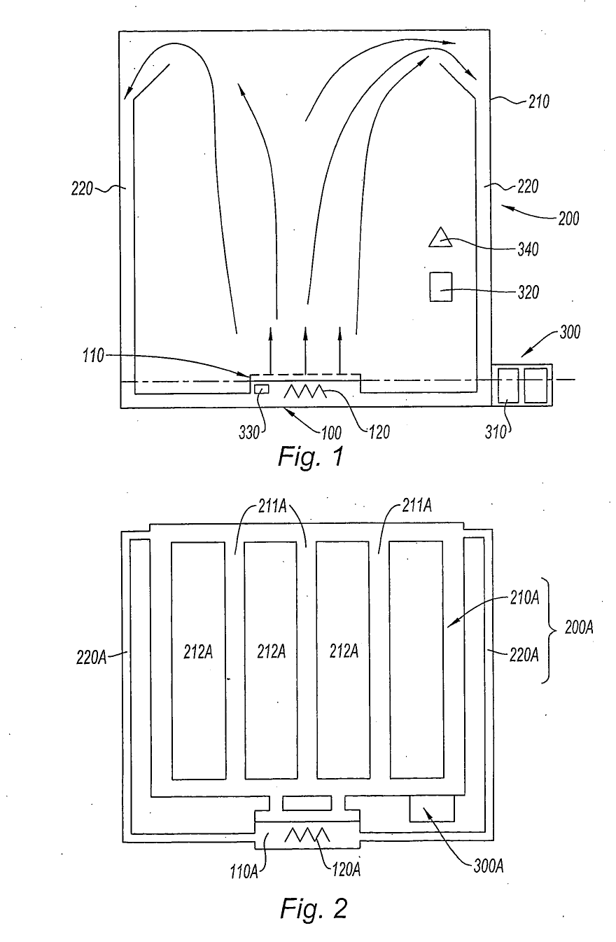

FIG. 1 shows a first embodiment of an electrical heating apparatus in the form of a panel constituting the emitting surface comprising a heating device 100 supplying a closed casing 200 while being managed by a control system 300. This heating apparatus operates principally by radiation, convection representing only a small part of the heat exchange. The radiation is emitted by the emitting surface formed by the panel, in particular the front face thereof.

The heating device 100 is formed by a vessel 110 of small volume in which a heating body 120 illustrated as an electrical resistor is arranged. The heating body 120 may also be installed outside the vessel 110 so that the enclosure formed by the panel 210 and the vessel 110 with the liquid can be sealed, leaving the heating body accessible for its installation or replacement. In that case, the vessel may advantageously be transparent and the heating body a halogen lamp. The vessel 110 receives a phase transition liquid having a low boiling temperature, such as an organic liquid, for example an alcohol, or ether or an HCFC, or a liquid having a low boiling temperature at reduced pressure or even very reduced pressure, such as water. The vessel 110 supplies vapour to the casing 200, shown here in the form of a panel, surmounting the vessel 110 and in communication with the latter. This closed casing 200 is a hermetic enclosure which is resistant to an internal pressure of the order of a few bars, for example 3.5 bar at maximum operation; it is intended to function at a maximum temperature of from 50 to 60° C. under operating conditions. According to some regulations, the maximum temperature of the emitting surface which may be reached is 60° C. in order to prevent burning accidents.

The panel 210, which is rectangular or square in this example, is bordered by two condensation ducts 220 which are open at the top portion of the enclosure. The ducts form condensation traps because they are separated from the direct circulation of vapour emitted by the vessel. They are cold regions in which the vapour condenses and descends to re-supply the vessel 110. The renewal of vapour in the duct(s) is brought about by pressure equilibrium. This circulation of fluid (vapour, condensate) permits a very high degree of temperature regularity.

For the sake of uniformity, it is preferable to provide a condensation duct on each side. It is also possible to provide only one condensation duct. Finally, the condensation duct(s) may be formed behind the panel.

The panel 210 forming the emitting surface may be composed of a single material, for example, welded sheet-metal, or may be composed of two materials, one being relatively insulating and the other heat-conductive so that only the front face is emitting and the rear face is insulating.

The enclosure 200 so formed is sealed in a leak-tight manner so that the liquid/vapour fluid circulates in a loop in the panel in accordance with the energy provided by the heating body 120, depending on the fixed desired temperature.

This heating body 120 is a resistor but it may also be another electrical/electronic component releasing heat, such as a halogen lamp.

The control system 300 regulates the operation of the apparatus and the safety thereof. The control system comprises an adjustable thermostat 310 enabling a desired temperature to be fixed. It is also connected to a pressure sensor 320 which is installed in the enclosure and which monitors the pressure in order to prevent any excess pressure, and also to a liquid-level sensor 330 which ensures that the heating body does not operate unless the vessel 110 contains a sufficient level of liquid and which checks for the absence of liquid. A temperature sensor 340 monitors the temperature of the emitting surface.

The heating apparatus described above having a casing 200 in the form of a panel may have a shape other than flat.

FIG. 2 shows another embodiment of an electrical heating apparatus, likewise having a casing 200A in the form of a panel 210A. At the lower portion, it comprises the vessel 110A with the heating body 120A. The vessel 110A communicates with the enclosure 200A into which it extends for the passage of the vapour.

The panel 210A comprises chimneys 211A by way of which the vapour rises. The casing 200A is bordered by two condensation ducts 220A, the entrance to which is at the upper portion of the enclosure and which are connected at the lower portion to the vessel 110A. The vapour thus condenses preferentially in those ducts, which have; in particular, a small cross-section, to descend there in the state of a condensate while also being driven by the renewal of vapour released by the vessel and the heating body. The condensation duct 220A is preferably, as in this case, an external duct in the form of a tube constituting a region which is all the colder because it is on the outside and exchanges heat more rapidly than if it were inside the panel; it thus traps the vapour and condenses it in order to re-supply the vessel 110A. The recycling of the vapour by condensation in the duct 220A permits the creation of vapour circulation at a very stable and uniform temperature. Advantageously, the condensation duct(s) is/are formed in the panel itself which is preferably formed by assembling two pieces of sheet-metal stamped with the different shapes.

The panel 210A is equipped with a control system 300A which manages operation for the regulation of the temperature by means of a thermostat and the safety functions, in order to set the pressure at a maximum value, for example 3.5, bar, and to prevent the heating body 120A from operating in the absence of liquid if the latter has evaporated completely.

The panel 210A is formed by assembling two plates, for example of sheet-metal, which is shaped to have chimneys and intermediate surfaces 212A which are cut out or constituted by the material, increasing the surface area for emission principally by radiation.

The volume of liquid in the heating apparatus, irrespective of the embodiment thereof, is defined in accordance with the form of the panel and the power required of the heating apparatus.

Several panels can be combined in a single temperature regulation system and can be managed by a single thermostat. The safety functions remain peculiar to each apparatus, such as protection in the case of the total evaporation of the liquid, switching off the heating body, or limiting the pressure inside the panel, in order not to exceed a pressure of, for example, 3.5 bar.

This permits a modular type of heating installation with modular elements which are each in a form like those shown in FIGS. 1 and 2 and which correspond to a basic power. The combination of two or more panels enables a range of powers to be obtained.

1. Electrical heating apparatus having an emitting surface, in particular in the form of a panel, characterized in that it comprises
A—a heating device having
a vessel receiving a small volume of low-boiling-temperature phase-transition liquid, and
an electrical heating body for the liquid in the vessel,
B—a closed casing forming the emitting surface, surmounting the vessel and in communication with the latter to form a pressure-resistant hermetic enclosure for the liquid vapour and the condensate.

2. Electrical heating apparatus according to claim 1, characterized by a condensation duct which leads into the upper portion of the enclosure and which is connected to the vessel.

3. Electrical heating apparatus according to claim 1, characterized in that the heating body is installed in the vessel.

4. Electrical heating apparatus according to claim 1, characterized in that the closed casing is a flat panel.

5. Electrical heating apparatus according to claim 1, characterized in that the casing comprises vapour circulation paths in the form of chimneys.

6. Electrical heating apparatus according to claim 1, characterized by a control system connected to the heating device and comprising a thermostat and/or a programmable or non-programmable electromechanical or electronic regulation system and/or protective means for preventing overheating or a rise in vapour pressure.

7. Electrical heating apparatus according to claim 1, characterized in that the heating body is an electrical resistor or a halogen lamp.

8. Electrical heating apparatus according to claim 1, characterized by a temperature sensor for the emitting surface.
